(19) United States
(12) Patent Application Publication
(10) Pub. No.: US 2004/0027394 A1
(43) Pub. Date: Feb. 12, 2004

(54) Virtual reality method and apparatus with improved navigation

(75) Inventor: Leslie Jerome Schonberg, Farmington Hills, MI (US)

Correspondence Address: KEVIN G. MIERZWA, ARTZ & ARTZ, P.C., 28333 TELEGRAPH ROAD, SUITE 250, SOUTHFIELD, MI, 48034, US

(73) Assignee: Ford Global Technologies, Inc., Dearborn, MI (US)

(21) Appl. No.: 10/064,732

(22) Filed: Aug. 12, 2002

(51) Int. Cl. G09G 5/00

(52) U.S. Cl. 345/850

(57) ABSTRACT

A virtual reality assembly 10 is provided, including a display element 12 projecting a virtual environment 16, and a plurality of way-point elements 20 each defined by its own way-point position 22. A user 18 can automatically move to one of said way-point positions 22 by simply selecting the corresponding way-point element 20.

### BACKGROUND OF INVENTION

The present invention relates generally to a virtual reality method and apparatus with improved navigation. More specifically, the present invention relates to a virtual reality method and apparatus improving navigation through the use of way-points.

Virtual reality technology in applications have progressed from hollywood-based imaginations into practical and useful applications. These applications have found utility in a wide variety of fields and industries. One known genre of applications are known as training applications. Virtual reality training applications allow users to develop important skills and experience without subjecting them to the hazards or costs of training within the industrial environment. The automotive industry has looked towards the field of virtual reality in order to train employees without subjecting them to the hazards of an automotive plant.

Virtual worlds may be utilized to familiarize employees with the plant environment, train employees on the proper use of plant equipment, and provide a detailed understanding of plant operations. In this fashion, an employee may be properly trained in a wide variety of operations, procedures, and protocols. Although the subjective content of a virtual reality world may only be limited in terms of imagination or desired reality, a users interaction with the virtual world often does not provide such flexibilities.

Difficulties arise when attempting to provide the user with effective, simplistic, and convenient interaction with the virtual reality world. One approach to improve user interaction has been through the development of high tech I/O devices. These devices run the gambit from video headgear to electronic bodysuits. Although such complex devices often succeed in improving the user's immersion into the virtual reality world, their cost and complexity can often serve to limit the use of virtual reality applications in more practical applications. In these practical applications, often a computer keyboard, monitor, and mouse or track ball may provide the sole source of communication between the user and the virtual reality world. In these scenarios, the use of such standard interface devices in combination with known methodologies has proven to create difficulties for the user in navigation to the virtual reality world.

Navigation through the virtual reality world utilizing such I/O devices, although practical, can be impractical and time-consuming when utilizing standard techniques. Users may be required to concentrate more on their placement and orientation controls than on the important training procedures the virtual reality world is intended to impart. Often such training requires the user to be positioned at precise locations within the virtual reality environment or move between sequences in such positions in order to properly glean the required knowledge. Considerable effort has been expended to control the user's response within the environment to mouse clicks or keyboard strokes, but often such controls remain over-responsive or under-responsive and thereby provide inefficient interaction. It would be highly desirable to improve the methods of navigation through the virtual reality world such that the user can quickly and efficiently reach the desired positions within the virtual environment. This would not only succeed in improving the ease of navigation, but would additionally improve the overall effectiveness of the virtual reality application.

### SUMMARY OF INVENTION

It is, therefore, an object of the present invention to provide a virtual reality method of assembly with improved navigation. It is a further object of the present invention to provide a virtual reality method and assembly that allows users to navigate through the virtual reality world in a simple and efficient manner.

In accordance with the objects of the present invention, a virtual reality assembly is provided. A virtual reality assembly includes a display element for depicting the virtual reality environment. The virtual reality assembly further includes a plurality of way-point elements positioned at locations within the virtual reality environment' Navigation through the virtual reality environment is simplified through the selection of one of the way-point elements as a travel destination.

Other objects and features of the present invention will become apparent when viewed in light of the detailed description of the preferred embodiment when taken in conjunction with the attached drawings and appended claims.

### BRIEF DESCRIPTION OF DRAWINGS

FIG. 1 is an illustration of an embodiment of a virtual reality assembly in accordance with the present invention;

FIG. 2 is an illustration of an alternate display view angle of the virtual reality assembly illustrated in FIG. 1; and

FIG. 3 is an illustration of the virtual reality assembly as described in FIG. 1, the illustration depicting a sample path through the virtual reality environment.

### DETAILED DESCRIPTION

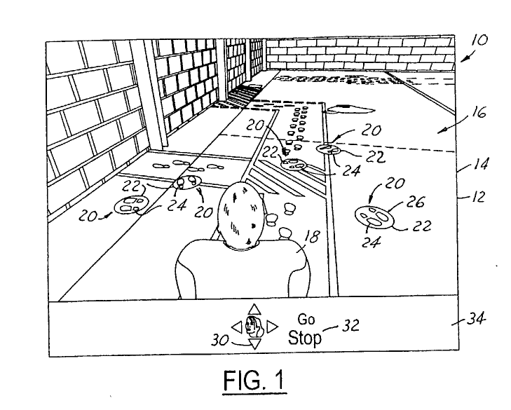

Referring now to FIG. 1, which is an illustration of a virtual reality assembly 10 in accordance with the present invention. The virtual reality assembly 10 includes a display element 12. The display element 12 is illustrated as a standard computer monitor display 14. It should be understood, however, that a wide variety of display elements 12 are contemplated by the present invention. These display elements 12 include, but are not limited to, optical projectors, virtual reality goggles, and holographic imaging. The display element 12 is utilized to project or display an image of the virtual environment 16 to the user of the virtual reality assembly 10.

As is understood, the virtual environment 16 can be designed to represent a wide variety of environments. Although an almost infinite range of such environments is contemplated by the present invention, the virtual environment 16 is illustrated representing an automotive manufacturing plant. Similarly, it is contemplated that virtual reality assembly 10 may be utilized to serve a wide variety of applications. These applications include, but are not limited to, familiarization of the user to the automotive plant environment, training of the user in plant operations, and education of the user in safety issues and procedures. In order to accomplish such applications, it is typically necessary for the user to navigate through the virtual environment 16, Although not necessary for the practice of the present invention, a visual representation of the user 18 may be represented within the virtual environment 16 in order to assist the user's visualization and orientation within the virtual environment 16. The visual representation 18 may additionally be useful for adequately displaying operational procedures or safety considerations.

Traditional navigation methods through the virtual reality environment 16 have often proven time-consuming and difficult. In addition, present navigational methods can cause user fatigue and negatively effect concentration. Precise placement and/or orientation of the user 18 can be crucial for the proper operation of the virtual environment assembly 10. The present invention improves the efficiency and ease of use of such navigation by including a plurality of way-points 20 positioned throughout the virtual reality environment 16. Each way-point 20 defines a specific placement 22 (also referred to as way-point position 22) within the virtual reality environment 16. In addition, it is contemplated that each way-point 20 may further include an orientation element 24 in addition to the way-point position 22 such that the user 18 can be moved to both a correct location and orientation. Although the way-points 20 need not be physically represented within the virtual environment 16, one embodiment contemplates the use of way-point icons 26 within the virtual environment 16 to represent way-point 20 locations and/or orientation.

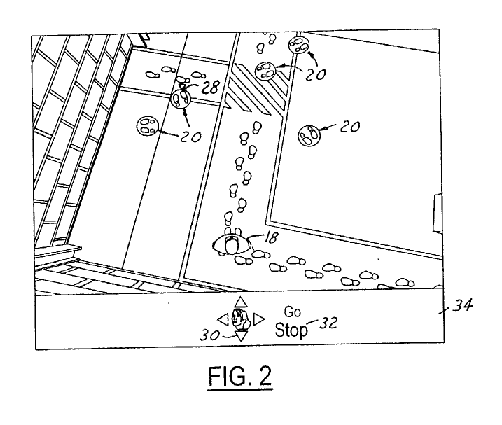

It is contemplated that the way-points 20 may be utilized in a variety of fashions in order to facilitate navigation through the virtual environment 16. In one embodiment, a cursor 28 may be utilized to select a particular way-point 20, thereby directing the user 18 towards that way-point position 22 and/or way-point orientation 24 (see FIG. 2.) It should be understood that the way-point icons 26 need not be utilized in order to effectuate this mode of navigation. By selecting an area within the virtual environment 16, the virtual environment assembly 10 can direct the user 18 to the nearest way-point 20 without the need for visual way-point icons 26.

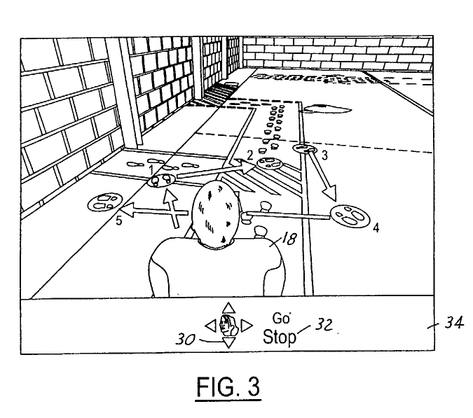

In an alternate embodiment (see FIG. 3), the plurality of way-points 20 may be sequenced. In this embodiment, the user 18 progresses through the virtual environment 16 by automatically progressing through way-points 20 in a predetermined order. This provides further reduced control complexity and may be highly valuable in applications requiring a precise sequence of movements. It should be understood that the arrows, indicating movement, illustrated in FIG. 3, are for illustrative purposes only and need not be physically represented within the virtual environment 16. Furthermore, the use of sequenced way-points 20 may be utilized in combination with a variety of other known directional controls in order to direct the user 18 between the sequenced way-points.

The user 18 may be directed between way-points through the use of traditional navigational controls such as an orientational control element 30 and a directional control element 32. Although one simplistic rendering of such control has been illustrated, a wide variety of orientational controls 30 and directional controls 32 would become obvious to one skilled in the art. The orientational controls 30 and directional controls 32 can be utilized to direct the user 18 towards a specific way-point 20. In addition, the orientational controls 30 may be utilized to allow the user 18 to visually explore the virtual environment 16 from a given position. Although these navigational controls may be accessed through a variety of known input devices, in one embodiment it is contemplated that a navigation band 34 displayed on the display element 12 may be utilized to provide the user 18 with access to navigation. In this fashion, simplistic I/O devices such as a mouse or a touch screen can be utilized to provide access to the navigational controls. This can allow a virtual reality assembly 10 to be installed in a wide variety of environments where complex I/O arrangements may be impractical.

While particular embodiments of the invention have been shown and described, numerous variations and alternative embodiments will occur to those skilled in the Accordingly, it is intended that the invention be limited only in terms of the appended claims.

1. A virtual reality assembly comprising:
a display element projecting a virtual environment;
a plurality of way-point elements, each of said plurality of way-point elements defined by a way-point position within said virtual environment;
wherein a user can automatically move to one of said way-point positions by selecting a corresponding one of said plurality of way-point elements.

2. A virtual reality assembly as described in claim 1, wherein each of said
plurality of way-point elements is defined by a way-point orientation; and
wherein said user automatically moves to one of said way-point orientations by selecting a corresponding one of said way-point elements.

3. A virtual reality assembly as described in claim 1 wherein said plurality of way-point elements comprise way-point icons projected within said virtual environment.

4. A virtual reality assembly as described in claim 1, wherein one of said plurality of way-point elements is selected utilizing a cursor.

5. A virtual reality assembly as described in claim 1, wherein one of said plurality of way-point elements is selected by automatically identifying the closest of said plurality of way-point elements to a cursor.

6. A virtual reality assembly as described in claim 1, wherein said plurality of way-point elements are sequenced such that said user moves through each of said plurality of way-point elements in a predetermined sequence.

7. A virtual reality assembly as described in claim 1, wherein said display element further comprises a navigation band including navigational controls.

8. A virtual reality assembly as described in claim 7, wherein said navigational controls comprise orientational controls and directional controls.

9. A virtual reality assembly as described in claim 1, wherein said virtual environment comprises an industrial training environment.

10. A virtual reality assembly comprising:
a display element projecting a virtual environment;
a plurality of way-point elements, each of said plurality of way-point elements defined by a way-point position within said virtual environment;
wherein a user navigates through said virtual environment through travel between said plurality of way-point elements, said user automatically moving to one of said way-point positions by selecting a corresponding one of said plurality of way-point elements.

11. A virtual reality assembly as described in claim 10, wherein each of said
plurality of way-point elements is defined by a way-point orientation;
and wherein said user automatically moves to one of said way-point orientations by selecting a corresponding one of said way-point elements.

12. A virtual reality assembly as described in claim 10, wherein said plurality of way-point elements comprise way-point icons projected within said virtual environment.

13. A virtual reality assembly as described in claim 10, wherein one of said plurality of way-point elements is selected utilizing a cursor.

14. A virtual reality assembly as described in claim 10, wherein one of said plurality of way-point elements is selected by automatically identifying the closest of said plurality of way-point elements to a cursor.

15. A virtual reality assembly as described in claim 10, wherein said plurality of way-point elements are sequenced such that said user moves through each of said plurality of way-point elements in a predetermined sequence.

16. A virtual reality assembly as described in claim 10, wherein said virtual environment comprises an industrial training environment.

17. A method of navigation through a virtual environment comprising:
selecting one of a plurality of way-point elements each defined by a way-point position within the virtual environment; and
transporting a user automatically to said way-point position.

18. A method of navigation through a virtual environment as described in claim 17 further comprising:
transporting said user automatically to a way-point orientation, said way-point element further defined by said way-point orientation.

19. A method of navigation through a virtual environment as described in claim 17 wherein said selecting one of a plurality of way-point elements comprises:
selecting one of a plurality of way-point elements utilizing a cursor.

20. A method of navigation through a virtual environment as described in claim 17 further comprising:
moving said user through each of said plurality of way-point elements in a predetermined sequence.
